(19) United States
(12) Patent Application Publication
(10) Pub. No.: US 2010/0272422 A1
(43) Pub. Date: Oct. 28, 2010

(54) RETORT FURNACE FOR HEAT AND/OR THERMOCHEMICAL TREATMENT

(75) Inventors: Maciej KORECKI, Swiebodzin (PL); Robert LUZENCZYK, Swiebodzin (PL); Józef OLEJNIK, Swiebodzin (PL)

Correspondence Address: OLIFF & BERRIDGE, PLC, P.O. BOX 320850, ALEXANDRIA, VA, 22320-4850, US

(73) Assignee: SECO/WARWICK S.A., SWIEBODZIN (PL)

(21) Appl. No.: 12/702,912

(22) Filed: Feb. 9, 2010

(30) Foreign Application Priority Data
Feb. 12, 2009 (PL) P-387256

(51) Int. Cl. F27D 11/12

(52) U.S. Cl. 392/416

(57) ABSTRACT

A retort furnace designed for heat and heat and chemical treatment in protective gas atmosphere, process gas atmosphere or in vacuum, equipped with a retort with a lid, made of steel or heat-resisting or creep-resisting alloys, separating the process atmosphere from the ambient atmosphere, with heating elements and thermal insulation outside the retort and with a cooling system. The radiation screens, in the form of at least two metal boards, are installed at supports located at the lid inside the retort; the heating elements are located behind the radiation screens, on the retort side and are separated with the metal screen. A few radiation sealing rings are placed in the extreme area of the brackets. The radiation screens and sealing rings, as well as the circumferential sealing rings permanently fixed in the casing of retort make up the system of reducing heat losses through radiation at the wall of the retort.

The subject matter of the invention is a retort furnace for heat and/or thermochemical treatment designed for technological processes in protective gas atmosphere, process gas atmosphere or in vacuum.

### BACKGROUND

Known constructions of retort furnaces have a chamber separating the working space from the ambient environment and ensuring achieving the required purity and quality of the process atmosphere. The retort chamber is made of heat-resisting or creep-resisting alloys and allows working temperatures up to 1300° C. The retorts have outside heat insulation and heating elements in between. The elements provide heat energy that is accumulated using the insulation and is further directed to the retort through radiation and natural convection. Heat is transferred within the retort—from its walls to the charge—in result of radiation, natural convection or convection forced using atmosphere mixers.

Usually the furnaces are equipped with systems for accelerated cooling after the heat treatment. That is achieved using blowers forcing air between the insulation and the external wall of the retort. Cold air flowing around the retort takes over the heat and heats up, then escapes outside through an open top hatch. There are also internal cooling systems operating in a closed circuit. Then, the atmosphere is drawn directly from the inside of the retort, forced through a heat exchanger and, cooled, returned to the retort.

### SUMMARY OF THE INVENTION

To allow opening of the furnace and putting the charge in the working space, the retort is equipped with a lid. The lid is sealed against the retort with a flange connection, where both the lid and the retort have flanges, and a rubber o-ring or a lip seal is the sealing element. The sealing flanges of the retort and the lid are water-cooled to ensure sufficiently low working temperature: about 80° C. The lid is closed and sealed with a mechanism that clamps both flanges with the seal in between. The lid also has thermal insulation preventing heat losses.

One of key process parameters of a furnace is evenness of temperature distribution in the working space. Depending on the heat treatment technology and quality requirements, the following temperature distribution evenness standards are applied, determining the class of the furnace (as specified in AMS 2750D): +/−28° C., +/−14° C., +/−10° C., +/−8° C., +/−6° C., and in the most advanced versions: +/−3° C.

The temperature distribution evenness in the working space depends on evenness and symmetry of the retort's heating system and on the size and evenness of heat losses. Factors negatively impacting the parameter include all heat bridges and losses in result of radiation or lack of heating elements. For that reason the size of the lid, located right next to the working space, is of crucial importance to the evenness of the temperature distribution inside the retort. There are heat bridges and the losses are increased by the water-cooled flanges, gas system ferrules and measurement sensors. In furnaces designed for vacuum operation, especially high vacuum, the ferrule of the pump system can take up a significant part of the lid surface and can cause very high heat losses that considerably upset the temperature distribution evenness, which makes it impossible to meet the +/−3° C. requirement, or even less stringent requirements.

The essential feature of the retort furnace consists in radiation screens in the form of at least two metal plates installed on brackets in the lid, inside the retort; moreover, the extreme areas of the brackets have radiation screens and radiation sealing rings as well as circumferential sealing rings permanently fixed in the retort casing.

It is preferable that the heating elements, preferably in the form of resistance wire, are located behind the radiation screens, on the inside of the retort.

It is also preferable that the heating elements are separated with a thermal screen.

Moreover, it is preferable that a temperature sensor is situated in the lid, in the range of the heating elements.

Use of the solution as invented ensures even temperature distribution at the whole length of the working space of the furnace in the range +/−2° C.

### BRIEF DESCRIPTION OF THE DRAWINGS

The following under-named figures represent a schematic drawings of an exemplary blower according to the invention:

FIG. 1—presents a cross-section of the furnace in the vertical plane going through the longitudinal axis of the furnace,

FIG. 2—presents a the furnace lid with an insulation system, hereinafter referred to as the thermal barrier, in the horizontal plane going through the longitudinal axis of the lid.

### INDICATIONS IN THE DRAWINGS

1—the thermal barrier
2.—the lid
3—the retort
4—the brackets
5—the radiation screens
5a—the radiation sealing rings
6—the circumferential sealing rings
7—the heating system
8—the temperature evening screen
9—the thermocouple
10—the ferrule
11—the heating elements
12—the master
13—the air blowers
14—the top hatches
15—the lower duct
16—the water-cooled flange

### DETAILED DESCRIPTION OF THE PREFERRED EMBODIMENTS

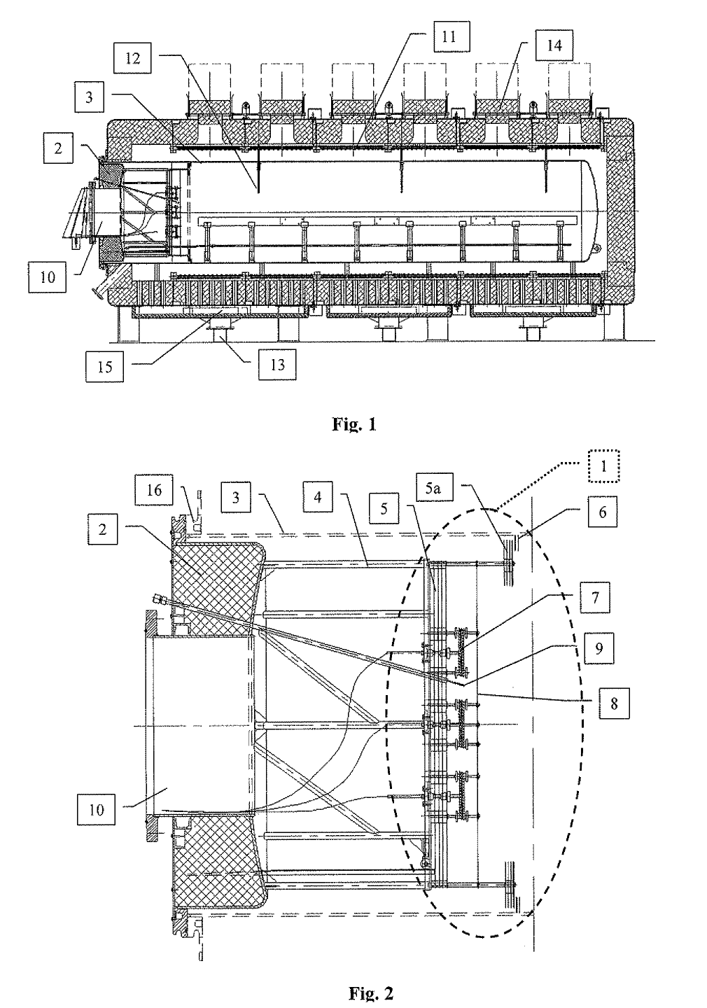

The invention will be further illustrated in an exemplary, not limiting application, for which FIG. 1 shows a cross-section of the furnace in the vertical plane going through the longitudinal axis of the furnace, and FIG. 2 shows the furnace lid with an insulation system, hereinafter referred to as the thermal barrier, in the horizontal plane going through the longitudinal axis of the lid.

The thermal barrier 1 (FIG. 2) is made up by brackets 4 located in the lid 2 inside the retort 3, used as support for radiation screens 5, in the form of metal screens with radiation sealing rings 5a, supporting circumferential sealing rings 6, permanently fixed at the inner surface of the retort 3. Additionally, there is a heating system 7 with a temperature evening screen 8 and thermocouple 9, ensuring temperature regulation of the thermal barrier 1 and its active operation. Keeping the temperature of the thermal barrier 1 the same as the temperature in the working space, the heat stream in the direction is eliminated and the temperature difference is reduced to minimum. At the same time the heat loss stream in the lid direction is completely compensated by the heating system 7.

The thermal barrier 1 is enclosed in the retort furnace (FIG. 1), which is designed for vacuum thermal processes, especially for annealing pipes made of austenitic alloys, on condition that the temperature distribution evenness in the working space is in the range +/−3° C., at the temperature not exceeding 650° C. The working space is 5.5 m long, 1.2 m wide and 0.16 m high (alternative width is 0.9 m and alternative height is 0.8 m).

The furnace is also equipped with a system of vacuum pumps based on a diffusion pump with 0.81 m inlet diameter, which requires installing a ferrule 10 with corresponding diameter in the lid 2.

The heating system is made up of heating elements n, evenly spaced outside the retort 3 and grouped in 3 longitudinal main zones, each of which consists of 3 subzones, circumferentially surrounding the retort 3 (9 subzones in total). The power of a subzone is 50 kW, while of a main zone −150 kW. The temperature is regulated in a cascade system (master-slave) and is based on 3 temperature sensors (K-type thermocouples), master 12, located inside the retort 3, right above the working space and 9 temperature sensors (K-type thermocouple), slave, located in 9 subzones, by the heating elements.

The cooling system consists of 3 air blowers 13 and 6 top hatches 14, two for each of the blowers. Blowers 13 force ambient air to the lower duct 15 and, further, between the insulation and the outer wall of the retort 3. The air, flowing around the retort 3, takes over the heat and escapes through upper hatches 14.

The active thermal barrier 1 is installed in the lid 2 of the retort 3; it consists of 5 metal screens 5 and 4 radiations sealing rings 5a. Additionally, it features two stationary screens in the form of circumferential sealing rings 6 situated in the internal wall of the retort 3 in order to close the clearance (when the lid 2 is closed) between the moving screens of the retort 5 and 5a and the retort wall 3.

The electric heating element 7 is made of resistance wire of 18 kW power. For evening of the temperature, the single metal screen 8 is installed on the working space side of the retort 3. The temperature in the thermal barrier heating element space 1 is regulated using the K-type thermocouple 9 and is set dynamically depending on the current measured temperature value in the retort 1 in the front barrier zone adjacent to the retort 1. In result of eliminating the temperature difference between the thermal barrier 1 and the working space of the retort 3, there is no heat loss stream toward the lid 2 deteriorating the temperature distribution evenness in the working space.

The system has been tested by heating the furnace and maintaining 600° C. and taking temperature distribution measurements in 11 extreme points of the working space. After stabilization of the temperature, power losses in specific zones were as follows: back zone—10.9 kW, middle zone—10.4 kW, front zone—19.5 kW and the heating elements 7 of the thermal barrier 1—4.2 kW. The higher load of the front zone results from the level of losses through the retort wall connected with the water-cooled flange 16. The power of the thermal barrier's heating system offsets the losses through the lid 2. The temperature adjustment system with the active thermal barrier 1 was stable and completely under control. The achieved temperature distribution evenness in the working space was very good: +/−2° C.

1. A retort furnace for heat and/or thermochemical treatment, equipped with a lid made of steel or heat-resisting or creep-resisting alloys, separating the process atmosphere from ambient atmosphere, with heating elements and thermal insulation on the outside of the retort, and a cooling system, wherein radiation screens, in the form of at least two metal boards, installed on brackets located at the lid inside the retort, and, additionally, radiation sealing rings and circumferential sealing rings, permanently fixed in the casing of the retort, located in the extreme areas of the brackets.

2. The retort furnace according to claim 1, wherein the heating elements have radiation screens on the inside of the retort, preferably in the form of resistance wire.

3. The retort furnace according to claim 2, wherein the heating elements are separated with a thermal screen.

4. The retort furnace according to claim 1, wherein the temperature sensor located in the range of heating elements of the lid.

5. The retort furnace according to claim 2, wherein the temperature sensor located in the range of heating elements of the lid.

6. The retort furnace according to claim 3, wherein the temperature sensor located in the range of heating elements of the lid.
